(19) United States
(12) Patent Application Publication
(10) Pub. No.: US 2026/0093351 A1
(43) Pub. Date: Apr. 2, 2026

(54) IN-VEHICLE INPUT DEVICE AND HOUSING DEVICE

(71) Applicant: Panasonic Automotive Systems Co., Ltd., Kanagawa (JP)

(72) Inventor: Hideaki ETO, Osaka (JP)

(73) Assignee: Panasonic Automotive Systems Co., Ltd., Kanagawa (JP)

(21) Appl. No.: 19/269,627

(22) Filed: Jul. 15, 2025

(30) Foreign Application Priority Data
Sep. 27, 2024 (JP) 2024-168824

(51) Int. Cl. G06F 3/041; B60H 1/00; B60K 35/10; B60N 2/75; G06F 3/01

(52) U.S. Cl. CPC G06F 3/0412; B60H 1/0065; B60K 35/10; B60N 2/797; G06F 3/016; B60K 2360/143; B60K 2360/774; G06F 2203/04105

(57) ABSTRACT

An in-vehicle input device includes: a resin panel having light transmissivity; a design sheet provided on a front surface of the resin panel, and including (i) a transmissive portion having light transmissivity and (ii) a design cover portion having light transmissivity lower than the light transmissivity of the transmissive portion; a touch sensor sheet having light transmissivity and provided to overlap at least the transmissive portion; a pressure-sensitive sensor sheet having light transmissivity and provided on a second surface of the touch sensor sheet to overlap at least the transmissive portion, the second surface being on an opposite side relative to a first surface of the touch sensor sheet on a resin panel side; and a substrate provided to overlap the design cover portion, and provided with a control circuit electrically connected with the touch sensor sheet and the pressure-sensitive sensor sheet.

### CROSS REFERENCE TO RELATED APPLICATION

The present application is based on and claims priority of Japanese Patent Application No. 2024-168824 filed on Sep. 27, 2024.

### FIELD

The present disclosure relates to an in-vehicle input device and a housing device.

### BACKGROUND

In recent years, input devices for carrying out functions of in-vehicle equipment items provided inside vehicles have come into wide use. Such input devices are provided at locations that are easy for operators to operate.

For example, as one example of these input devices, Patent Literature (PTL) 1 discloses a vehicle control device that includes: a display module with a display on the front surface of the display module; a touch-sensitive layer; a transparent cover attached to the front surface of the display module whose front surface has a tactile feedback area; and a control unit configured to receive a user input via the touch-sensitive layer to trigger a vehicle function in response to the user input. In PTL 1, the vehicle control device is attached to an armrest.

### CITATION LIST

### Patent Literature

PTL 1: Japanese Unexamined Patent Application Publication (Translation of PCT Application) No. 2022-502802

### SUMMARY

However, the vehicle control device according to PTL 1 can be improved upon.

In view of this, the present disclosure provides an in-vehicle input device, etc., that are capable of improving upon the above related art.

An in-vehicle input device according to one aspect of the present disclosure is an in-vehicle input device provided in a vehicle. The in-vehicle input device includes: a resin panel having light transmissivity; a design sheet provided on a front surface of the resin panel and including (i) a transmissive portion having light transmissivity and (ii) a design cover portion with a design, the design cover portion having light transmissivity lower than the light transmissivity of the transmissive portion; a touch sensor sheet having light transmissivity and provided on a back surface of the resin panel to overlap at least the transmissive portion in a thickness direction of the in-vehicle input device, the back surface being on an opposite side relative to the front surface of the resin panel; a pressure-sensitive sensor sheet having light transmissivity and provided on a second surface of the touch sensor sheet to overlap at least the transmissive portion in the thickness direction, the second surface being on an opposite side relative to a first surface of the touch sensor sheet on a resin panel side; and a substrate provided to overlap the design cover portion in the thickness direction, and provided with a control circuit electrically connected with the touch sensor sheet and the pressure-sensitive sensor sheet.

In addition, a housing device according to one aspect of the present disclosure includes: the in-vehicle input device; a housing portion in which an opening is formed; and a lid portion on which the in-vehicle input device is provided and which opens and closes the opening.

The in-vehicle input device, etc., according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram schematically illustrating a housing device according to an embodiment which is provided in a vehicle.

FIG. 2 is a top view of the housing device according to the embodiment which is provided in the vehicle.

FIG. 3 is a cross-sectional view of the housing device taken along line A-A shown in FIG. 2.

FIG. 4 is a block diagram illustrating an in-vehicle input device according to the embodiment which is provided in the vehicle.

FIG. 5 is a cross-sectional view of another housing device.

FIG. 6 is a diagram schematically illustrating the in-vehicle input device according to the embodiment provided on a steering wheel.

### DESCRIPTION OF EMBODIMENTS

Hereinafter, embodiments will be described in detail with reference to the drawings.

Note that the embodiments below each describe a general or specific example. The numerical values, shapes, materials, elements, the arrangement and connection of the elements, etc., in the following embodiments are mere examples, and therefore do not intend to limit the present disclosure. Furthermore, among the elements in the embodiments below, those not recited in any one of the independent claims will be described as optional elements.

In addition, the drawings are schematic diagrams, and do not necessarily provide strictly accurate illustrations. Throughout the drawings, the same reference numeral is given to the same element.

In the following embodiments, expressions such as a container shape, a forward direction, etc., are used. For example, a container shape and a forward direction not only mean a perfect container or a perfectly forward direction, but also mean substantially container in shape and substantially forward direction. In other words, these expressions mean to include errors of about several percent. Moreover, a container shape and forward direction means a container and a forward direction to the extent that the advantageous effects according to the present disclosure can be achieved. The same applies to other expressions with “shape” and “direction.”

### EMBODIMENT

### [Configuration]

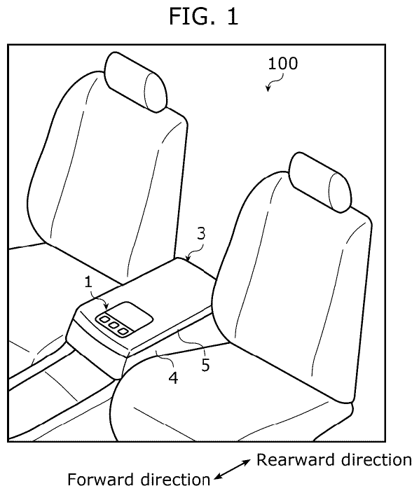

First of all, in-vehicle input device 1 and housing device 3 provided in vehicle 100 will be described with reference to FIG. 1 through FIG. 6.

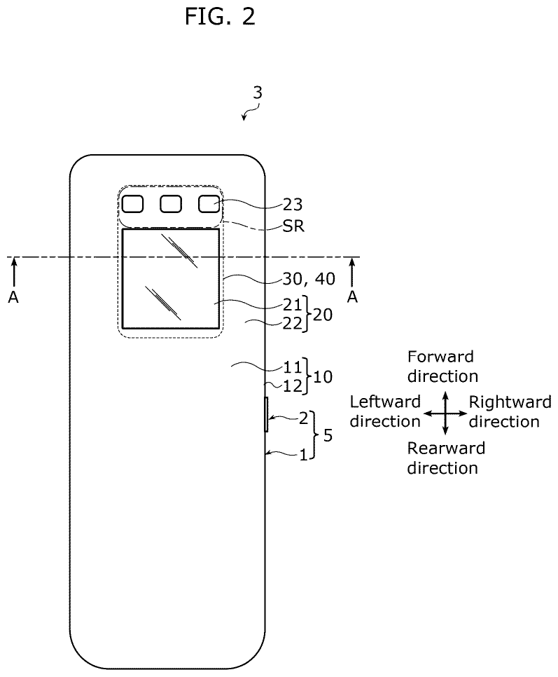

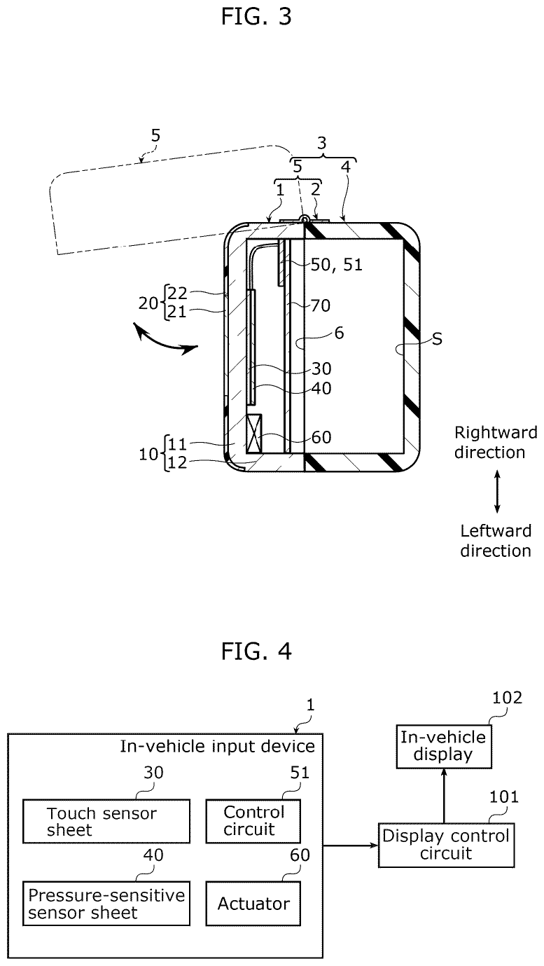

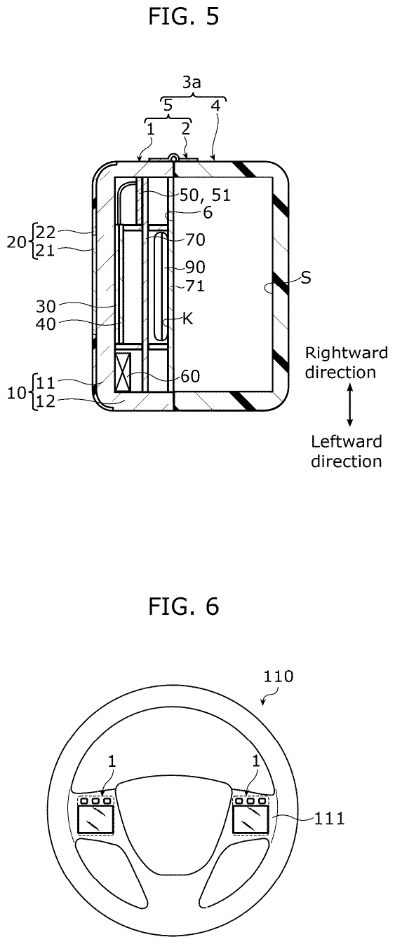

FIG. 1 is a diagram schematically illustrating housing device 3 according to an embodiment which is provided in vehicle 100. FIG. 2 is a top view of housing device 3 according to the embodiment which is provided in vehicle 100. FIG. 3 is a cross-sectional view of housing device 3 taken along line A-A shown in FIG. 2. FIG. 4 is a block diagram illustrating in-vehicle input device 1 according to the embodiment which is provided in vehicle 100. FIG. 5 is a cross-sectional view of another housing device, housing device 3a. FIG. 6 is a diagram schematically illustrating in-vehicle input device 1 according to the embodiment which is provided on steering wheel 110.

As illustrated in FIG. 1, vehicle 100 is provided with housing device 3. Housing device 3 is used as an in-vehicle console box. Housing device 3 is provided between the driver's seat and a passenger seat next to the driver's seat of vehicle 100. Housing device 3 functions as, for example, an armrest. Housing device 3 is provided in a position where a passenger can rest their forearm, wrist, elbow, etc., when the passenger sits in the driver's seat.

Specifically, housing device 3 includes housing portion 4 and lid portion 5.

As illustrated in FIG. 2 and FIG. 3, housing portion 4 is a long container in a direction parallel to the forward direction and rearward direction (hereinafter called the forward-rearward direction) of vehicle 100, and includes opening 6 in the top end. Housing portion 4 is provided with housing space S for accommodating an object from opening 6. In other words, opening 6 is a boundary between housing space S and the outside, and faces upward.

Lid portion 5 is provided so as to cover opening 6 in housing portion 4, and is provided to be capable of being opened and closed with respect to opening 6 in housing portion 4.

Lid portion 5 includes in-vehicle input device 1 and shaft portion 2.

In-vehicle input device 1 is a main unit of the lid. In-vehicle input device 1 closes (covers) opening 6 of housing portion 4 when in the closed position, and opens opening 6 of housing portion 4 when in the open position.

Shaft portion 2 pivotally supports in-vehicle input device 1 with respect to opening 6 of housing 4. Accordingly, in-vehicle input device 1 displaces between the closed position and open position by pivoting about shaft portion 2.

In the present embodiment, shaft portion 2 of lid portion 5 is provided on the right side of housing portion 4. The center of shaft portion 2 is in a direction parallel to the forward-rearward direction of vehicle 100. When housing space S of housing device 3 according to the present embodiment is opened up, lid portion 5 is displaced toward the right side of vehicle 100 to be in the open position. Moreover, when lid portion 5 is closed, lid portion 5 is configured as the top surface of housing device 3. Housing device 3 according to the present embodiment can be said as a single-lid type housing device 3. It should be noted that shaft portion 2 of lid portion 5 may be provided on the left side of housing portion 4. In this case, when housing space S of housing device 3 is opened up, lid portion 5 is displaced toward the left side of vehicle 100 to be in the open position.

Although the above has presented an example of a single-lid type housing device 3, the present embodiment is not limited to the foregoing. For example, housing device 3 may include two lid portions 5 provided side by side in the left-right direction (also referred to as the leftward direction and rightward direction). In this case, the right lid portion 5 may be displaced toward the right side of vehicle 100 to be in the open position and the left lid portion 5 may be displaced toward the left side of vehicle 100 to be in the open position. Moreover, when these two lid portions 5 are closed, the two lid portions 5 are joined side by side to be configured as the top surface of housing device 3. Housing device 3 according to the present embodiment can be said as a double-lid type housing device 3.

It should be noted that the direction in which lid portion 5 opens and closes are not limited to the right side and left side. Lid portion 5 may be displaced toward the front side to be in the open position and may be displaced toward the rear side to be in the open position. In this case, housing device 3 may include two lid portions 5 provided side by side in the left-right direction. The right lid portion 5 may be displaced toward the front side or rear side of vehicle 100 to be in the open position and the left lid portion 5 may be displaced toward the front side or rear side of vehicle 100 to be in the open position. Moreover, lid portion 5 may be a single lid in this case also.

In addition, for example, housing device 3 may include two lid portions 5 provided aligned in the forward-rearward direction. In this case, the front lid portion 5 may be displaced toward the front side of vehicle 100 to be in the open position and the rear lid portion 5 may be displaced toward the rear side of vehicle 100 to be in the open position.

Furthermore, housing device 3 may include two sets of lid portions 5 provided side by side in the left-right direction, where each set includes two lid portions 5 aligned in the forward-rearward direction. In this case, as described above, each set of lid portions 5 of the two sets may be displaced toward the front side and rear side to be in the open position or may be displaced toward the right side and left side to be in the open position.

Moreover, when housing device 3 includes two lid portions 5, each of lid portions 5 may be provided with in-vehicle input device 1. When housing device 3 includes three or more lid portions 5, at least one of lid portions 5 may be provided with in-vehicle input device 1. In addition, the number of lid portions 5 to be provided for housing device 3 is not limited to one or two, and may be three or more.

Out of lid portions 5, in-vehicle input device 1 is provided in lid portion 5 on the front side of vehicle 100.

Specifically, as illustrated in FIG. 2 through FIG. 4, in-vehicle input device 1 includes resin panel 10, design sheet 20, touch sensor sheet 30, pressure-sensitive sensor sheet 40, substrate 50, actuator 60, and first light-transmissive cover 70.

Resin panel 10 is a main structural element in in-vehicle input device 1 provided for covering opening 6 in housing portion 4. Resin panel 10 includes resin materials, etc., so as to also function as an armrest that can support the forearm, wrist, elbow, etc., of a passenger.

Resin panel 10 includes top plate 11 and upright wall portion 12.

Top plate 11 is a portion on which the forearm, wrist, elbow, etc., are rested when lid portion 5 provided with in-vehicle input device 1 is in the closed position. As illustrated in FIG. 3, upright wall portion 12 extends from the outer edge of top plate 11. From the above, resin panel 10 is in the shape of a container. Resin panel 10 accommodates, inside resin panel 10, touch sensor sheet 30, pressure-sensitive sensor sheet 40, substrate 50, actuator 60, and first light-transmissive cover 70.

Design sheet 20 is provided on the front surface of top plate 11 in resin panel 10, and is laid on top plate 11 of resin panel 10. The front surface of top plate 11 is the top surface when lid portion 5 is in the closed position. Design sheet 20 may be, for example, (i) printed on the front surface of resin panel 10, (ii) integrally molded in resin on the front surface of resin panel 10, (iii) affixed with a light-transmissive adhesive, etc., or (iv) provided on the front surface of top plate 11 by being coupled to resin panel 10.

Design sheet 20 includes transmissive portion 21 and design cover portion 22.

Transmissive portion 21 is configured to allow light to transmit in a thickness direction of in-vehicle input device 1. The thickness direction is, for example, the up-down direction when lid portion 5 in which in-vehicle input device 1 closes opening 6.

Design cover portion 22 has light transmissivity lower than the light transmissivity of transmissive portion 21. Design cover portion 22 includes a material that allows less light to transmit than transmissive portion 21 allows, but may have a small degree of light transmissivity.

Design cover portion 22 includes symbol region SR. Symbol region SR includes design 23. Design 23 is a symbol mark or the like associated with the shape, pattern, and function of a switch for a passenger to input an instruction to in-vehicle input device 1, for example.

When lid portion 5 is in the closed position, symbol region SR is located more toward the front side of vehicle 100 than transmissive portion 21 is. In other words, when a passenger rests their forearm, wrist, elbow, etc., on housing device 3, symbol region SR is provided in a position easy to operate, by a finger, design 23 of symbol region SR, namely a switch.

Design cover portion 22 is configured to have an area size greater than the area size of transmissive portion 21. While the internal state of housing device 3 (an object accommodated in housing space S) can be visually checked via transmissive portion 21, design cover portion 22 can hide substrate 50, actuator 60, the internal structure of lid portion 5, etc.

Touch sensor sheet 30 is a light-transmissive, capacitance-type sensor sheet, and is configured to detect a position of an operation performed by a passenger on design sheet 20. Touch sensor sheet 30 is provided on the back surface of resin panel 10 which is on the opposite side relative to the front surface of resin panel 10, and is laid on resin panel 10. Specifically, touch sensor sheet 30 is provided so as to overlap at least transmissive portion 21 of design sheet 20 in the thickness direction. In the present embodiment, touch sensor sheet 30 is provided so as to overlap, in the thickness direction, transmissive portion 21 as well as symbol region SR of design cover portion 22. Touch sensor sheet 30 may be, for example, provided on the back surface of resin panel 10 by being coupled to resin panel 10.

The portion of touch sensor sheet 30 in which touch sensor sheet 30 overlaps symbol region SR of design cover portion 22 may be able to accept operations corresponding to design 23 by a passenger touching design 23 of symbol region SR. Moreover, the portion of touch sensor sheet 30 in which touch sensor sheet 30 overlaps transmissive portion 21 may be able to accept touchscreen gesture operations, such as swiping, pinching in, pinching out, etc.

Pressure-sensitive sensor sheet 40 is a light-transmissive, piezoelectric sensor sheet, and is configured to be capable of detecting pressure (operation) applied by a passenger to design sheet 20. For example, when an operator performs an operation in a range detectable by touch sensor sheet 30 while viewing in-vehicle display 102 provided in vehicle 100, the operator may press the surface of design sheet 20 when the operator selects and determines an operation detail. Pressure-sensitive sensor sheet 40 can detect the above-mentioned press.

Pressure-sensitive sensor sheet 40 is provided on a second surface of touch sensor sheet 30 which is on the opposite side relative to a first surface of touch sensor sheet 30 on the resin panel 10 side, and is laid on touch sensor sheet 30. Specifically, pressure-sensitive sensor sheet 40 is provided so as to overlap at least transmissive portion 21 in the thickness direction. In the present embodiment, pressure-sensitive sensor sheet 40 has the size and shape equivalent to the size and shape of touch sensor sheet 30, and is provided so as to overlap, in the thickness direction, transmissive portion 21 as well as symbol region SR of design cover portion 22. For example, in a state of being laid on touch sensor sheet 30, pressure-sensitive sensor sheet 40 may be provided on the back surface side of resin panel 10 by being coupled to resin panel 10.

Substrate 50 is provided with control circuit 51 that is electrically connected with touch sensor sheet 30 and pressure-sensitive sensor sheet 40. Substrate 50 is provided so as to overlap design cover portion 22 in the thickness direction. Stated differently, substrate 50 is provided so as to avoid overlapping transmissive portion 21 in the thickness direction. Accordingly, substrate 50 is not provided between transmissive portion 21 and housing space S in the thickness direction, preventing substrate 50 from blocking the sight when the state of housing space S is visually checked via transmissive portion 21. Therefore, the state of housing space S can be visually checked with ease.

Control circuit 51 is also electrically connected with actuator 60. Control circuit 51 can control actuator 60 based on an input detected by touch sensor sheet 30 and pressure-sensitive sensor sheet 40. For example, control circuit 51 is configured to control actuator 60 by outputting (i) to display control circuit 101 provided in vehicle 100, information corresponding to an input detected by touch sensor sheet 30 and pressure-sensitive sensor sheet 40 and (ii) to actuator 60, a vibration signal corresponding to a signal from display control circuit 101.

Control circuit 51 can output information corresponding to an input detected by touch sensor sheet 30 and pressure-sensitive sensor sheet 40 to display control circuit 101 provided in vehicle 100. Display control circuit 101 can cause in-vehicle display 102 provided in vehicle 100 to display the information corresponding to the input. Since in-vehicle display 102 and touch sensor sheet 30 are different elements, or stated differently, since in-vehicle display 102 and touch sensor sheet 30 are not combined to configure a touch panel, in-vehicle display 102 is not provided between transmissive portion 21 and housing space S in the thickness direction. Therefore, the state of housing space S can be visually checked via transmissive portion 21 with ease.

Moreover, control circuit 51 may be able to operate in-vehicle devices provided in vehicle 100 based on inputs detected by touch sensor sheet 30 and pressure-sensitive sensor sheet 40. The in-vehicle devices are an air conditioner, a lighting device, an acoustic device, in-vehicle display 102, a navigation system, power windows, etc.

Actuator 60 is provided so as to overlap design cover portion 22 in the thickness direction. Stated differently, actuator 60 is provided so as to avoid overlapping transmissive portion 21 in the thickness direction. In the present embodiment, actuator 60 is provided on the back surface of resin panel 10. Accordingly, actuator 60 is not provided between transmissive portion 21 and housing space S in the thickness direction, preventing actuator 60 from blocking the sight when the state of housing space S is visually checked via transmissive portion 21. Therefore, the state of housing space S can be visually checked with ease.

Actuator 60 can vibrate at least transmissive portion 21. Specifically, when a passenger performs an operation on touch sensor sheet 30 and pressure-sensitive sensor sheet 40, control circuit 51 outputs (i) information corresponding to an input detected by touch sensor sheet 30 and pressure-sensitive sensor sheet 40 to display control circuit 101 provided in vehicle 100 and (ii) a vibration signal corresponding to a signal from display control circuit 101 to actuator 60. Actuator 60 is configured to vibrate by obtaining a vibration signal from control circuit 51. When actuator 60 vibrates, vibrations produced are transmitted to resin panel 10 and also to design sheet 20. With this, transmissive portion 21 vibrates, and the vibrations allow the passenger to understand the fact that an instruction has been input (operated) to touch sensor sheet 30 and pressure-sensitive sensor sheet 40.

First light-transmissive cover 70 is provided on the opposite side relative to the touch sensor sheet 30 side of pressure-sensitive sensor sheet 40, and is provided on upright wall portion 12 of resin panel 10 so as to cover pressure-sensitive sensor sheet 40, touch sensor sheet 30, and substrate 50 which are provided inside resin panel 10. Since actuator 60 is provided inside resin panel 10 in the present embodiment, first light-transmissive cover 70 also covers actuator 60. First light-transmissive cover 70 can be said as, for example, the bottom cover forming the bottom surface of lid portion 5, and substrate 50 is provided on first light-transmissive cover 70. First light-transmissive cover 70 has light transmissivity. Therefore, the state of housing space S can be visually checked via transmissive portion 21. First light-transmissive cover 70 makes it difficult for dust and dirt to enter inside resin panel 10 in the shape of a container. First light-transmissive cover 70 is one example of light-transmissive covers.

As described above, transmissive portion 21 of design sheet 20, resin panel 10, touch sensor sheet 30, pressure-sensitive sensor sheet 40, and first light-transmissive cover 70 are provided so as to overlap each other in the stated order. The above-described transmissive portion 21 of design sheet 20, resin panel 10, touch sensor sheet 30, pressure-sensitive sensor sheet 40, and first light-transmissive cover 70 have light transmissivity. For this reason, although lid portion 5 on which in-vehicle input device 1 is provided is in the closed position, the state of housing space S can be visually checked from outside. In other words, a passenger can understand an object accommodated in housing space S without opening lid portion 5.

Note that the entire resin panel 10 may have light transmissivity, only top plate 11 of resin panel 10 may have light transmissivity, or only a portion where touch sensor sheet 30, etc., are provided may have light transmissivity.

In-vehicle input device 1 of housing device 3a further includes second light-transmissive cover 71, as illustrated in FIG. 5. Second light-transmissive cover 71 is provided on the opposite side relative to the pressure-sensitive sensor sheet 40 side of first light-transmissive cover 70, covers first light-transmissive cover 70, and is provided on upright wall portion 12 of resin panel 10 so as to create space K. In other words, housing device 3a may further include space K that is capable of accommodating terminal device 90.

Specifically, lid portion 5 may include space K for accommodating terminal device 90. Terminal device 90 is, for example, a smartphone and a tablet terminal. Space K is a space between first light-transmissive cover 70 and second light-transmissive cover 71. Space K overlaps transmissive portion 21 in the thickness direction. For this reason, the state of space K can be visually checked via transmissive portion 21. In other words, it is possible to understand an object accommodated in space K. Space K can accommodate terminal device 90, and may allow terminal device 90 to be operable from outside housing device 3a via transmissive portion 21 of design sheet 20, etc. Specifically, for example, control circuit 51 and terminal device 90 are wirelessly connected, and control circuit 51 transmits information from touch sensor sheet 30 and pressure-sensitive sensor sheet 40 to terminal device 90. The screen of terminal device 90 is updated based on the information transmitted to terminal device 90. With this, terminal device 90 can be operated from outside housing device 3a. Moreover, control circuit 51 may receive vibration information from terminal device 90, and may vibrate actuator 60 based on the received vibration information. The way of accommodating terminal device 90 in space K may be by opening second light-transmissive cover 71 to accommodate terminal device 90 in space K or may be through a gate formed in lid portion 5 for inserting terminal device 90 into space K. With this, it is possible to readily check that terminal device 90 is accommodated in housing device 3a via in-vehicle input device 1.

Note that in-vehicle input device 1 according to the above-described embodiment is exemplified as being applied to an armrest, but in-vehicle input device 1 is not limited to be applied to an armrest. For example, as illustrated in FIG. 6, in-vehicle input device 1 may be provided on spoke 111 of steering wheel 110 as steering wheel switches. In this case, a portion of spoke 111 of steering wheel 110 has light transmissivity. This improves visibility of switches, etc., in the bottom portion of the meter inside the passenger cabin via steering wheel 110. Moreover, this portion of spoke 111 having light transmissivity improves design quality of spoke 111. Although FIG. 6 presents the example of steering wheel 110 provided with two in-vehicle input devices 1, the number and location of in-vehicle input devices 1 to be provided on steering wheel 110 are not limited to the present embodiment.

### Advantageous Effects

Next, advantageous effects produced by in-vehicle input device 1 and housing devices 3 and 3a according to the present embodiment will be described.

In PTL 1, the vehicle control device is provided on the front surface of an armrest. For example, when a housing device including a housing space for accommodating an object inside an armrest is provided, the vehicle control device having no light transmissivity provided on the front surface of the housing device makes it difficult to understand the state of the housing space, in other words, the internal state of the housing device.

In view of the above, as has been described, in-vehicle input device 1 according to technical aspect 1 of the present embodiment is in-vehicle input device 1 provided in vehicle 100. In-vehicle input device 1 includes: resin panel 10 having light transmissivity; design sheet 20 provided on the front surface of resin panel 10 and including (i) transmissive portion 21 having light transmissivity and (ii) design cover portion 22 with design 23 which has light transmissivity lower than the light transmissivity of transmissive portion 21; touch sensor sheet 30 having light transmissivity and provided on the back surface of resin panel 10 to overlap at least transmissive portion 21 in a thickness direction of in-vehicle input device 1, where the back surface is on the opposite side relative to the front surface of resin panel 10; pressure-sensitive sensor sheet 40 having light transmissivity and provided on a second surface of touch sensor sheet 30 to overlap at least transmissive portion 21 in the thickness direction, where the second surface is on the opposite side relative to a first surface of touch sensor sheet 30 on the resin panel 10 side; and substrate 50 provided to overlap design cover portion 22 in the thickness direction, and provided with control circuit 51 electrically connected with touch sensor sheet 30 and pressure-sensitive sensor sheet 40.

According to the above, a passenger can understand the internal state of housing device 3 or 3a provided in vehicle 100 via transmissive portion 21 of design sheet 20, resin panel 10, touch sensor sheet 30, and pressure-sensitive sensor sheet 40.

Therefore, with this in-vehicle input device 1, the internal state of housing device 3 or 3a can be understood.

In particular, since pressure-sensitive sensor sheet 40 is in the shape of a sheet, pressure-sensitive sensor sheet 40 can inhibit an increase in the thickness of in-vehicle input device 1.

Moreover, design cover portion 22 and substrate 50 are provided so as to overlap each other. Stated differently, substrate 50 is provided so as to avoid overlapping transmissive portion 21 in the thickness direction. Accordingly, when the opposite side relative to the front surface of resin panel 10 (the internal state of housing device 3 or 3a) is visually checked via transmissive portion 21, blocking the sight by substrate 50 can be prevented. Therefore, the opposite side relative to the front surface of resin panel 10 (the internal state of housing device 3 or 3a) can be visually checked with ease.

In addition, in-vehicle input device 1 according to technical aspect 2 of the present embodiment is in-vehicle input device 1 according to technical aspect 1 which further includes a light-transmissive cover (first light-transmissive cover 70) having light transmissivity and provided on the opposite side relative to the touch sensor sheet 30 side of pressure-sensitive sensor sheet 40, to cover pressure-sensitive sensor sheet 40, touch sensor sheet 30, and substrate 50.

According to the above, first light-transmissive cover 70 has light transmissivity. Accordingly, when the opposite side relative to the front surface of resin panel 10 (the internal state of housing device 3 or 3a) is visually checked via transmissive portion 21, the opposite side relative to first light-transmissive cover 70 (the internal state of housing device 3 or 3a) can be visually checked.

Moreover, in-vehicle input device 1 according to technical aspect 3 of the present embodiment is in-vehicle input device 1 according to technical aspect 1 or 2 which further includes actuator 60 that is provided to overlap design cover portion 22 in the thickness direction and vibrates at least transmissive portion 21.

This prevents actuator 60 from (i) covering transmissive portion 21 of design sheet 20 and (ii) making the understanding of the internal state of housing device 3 or 3a difficult for a passenger.

Moreover, since design cover portion 22 and actuator 60 are provided to overlap each other, it is difficult to visually check the structure, etc., of actuator 60. This inhibits deterioration in the entire design quality of in-vehicle input device 1.

In addition, in-vehicle input device 1 according to technical aspect 4 of the present embodiment is in-vehicle input device 1 according to technical aspect 3. In this case, actuator 60 is electrically connected to control circuit 51, and control circuit 51 controls actuator 60 based on an input detected by touch sensor sheet 30 and pressure-sensitive sensor sheet 40.

With this, a passenger can operate actuator 60 by performing an operation on touch sensor sheet 30 and pressure-sensitive sensor sheet 40 as an input. With this, at least transmissive portion 21 vibrates. Accordingly, the passenger can understand the fact that an instruction has been input (operated) to touch sensor sheet 30 and pressure-sensitive sensor sheet 40.

Moreover, in-vehicle input device 1 according to technical aspect 5 of the present embodiment is in-vehicle input device 1 according to any one of technical aspects 1 to 4. In this case, control circuit 51 outputs information corresponding to an input detected by touch sensor sheet 30 and pressure-sensitive sensor sheet 40 to display control circuit 101 provided in vehicle 100.

This allows in-vehicle display 102 and touch sensor sheet 30 to be different elements, and thus in-vehicle display 102 can be provided to avoid overlapping transmissive portion 21 in the thickness direction. Therefore, the opposite side relative to the front surface of resin panel 10 (the internal state of housing device 3 or 3a) can be visually checked with ease.

In addition, in-vehicle input device 1 according to technical aspect 6 of the present embodiment is in-vehicle input device 1 according to any one of technical aspects 1 to 5. In this case, vehicle 100 is provided with housing device 3 or 3a. Housing device 3 or 3a provided in vehicle 100 is an armrest including housing portion 4 in which opening 6 is formed and lid portion 5 that opens or closes opening 6. In-vehicle input device 1 is provided on lid portion 5.

According to the above, a passenger can readily perform an operation on touch sensor sheet 30 and pressure-sensitive sensor sheet 40 using their finger while resting their forearm, wrist, elbow, etc., on housing device 3 or 3a. This facilitates operability of in-vehicle devices for a passenger while resting their arm.

Moreover, in-vehicle input device 1 according to technical aspect 7 of the present embodiment is in-vehicle input device 1 according to any one of technical aspects 1 to 6. In this case, in-vehicle input device 1 is provided on steering wheel 110 of vehicle 100.

This in-vehicle input device 1 also produces the same advantageous effects as described above.

In addition, housing devices 3 and 3a according to technical aspect 8 of the present embodiment each include in-vehicle input device 1 according to any one of technical aspects 1 to 7, housing portion 4 in which opening 6 is formed, and lid portion 5 on which in-vehicle input device 1 is provided and which opens and closes opening 6.

These housing devices 3 and 3a also produce the same advantageous effects as described above.

In addition, housing devices 3 and 3a according to technical aspect 9 of the present embodiment are housing devices 3 and 3a according to technical aspect 8. In this case, space K capable of accommodating terminal device 90 is created in lid portion 5, and overlaps transmissive portion 21 in the thickness direction.

According to the above, the state of space K can be visually checked via transmissive portion 21. In other words, it is possible to understand an object, such as terminal device 90, which is accommodated in space K.

### [Other Variations]

Hereinbefore, the in-vehicle input device and housing devices according to the present disclosure have been described based on the above-described embodiment, but the present disclosure is not limited to the embodiment. The present disclosure may encompass embodiments arrived at by a person of skill in the art making various modifications to the embodiments as long as the embodiments do not depart from the spirit of the present disclosure.

For example, the control circuit, etc., included in the in-vehicle input device and housing devices according to the above-described embodiment are typically implemented as large-scale integration (LSI) circuits that are integrated circuits. These circuits each may be individually implemented as a single chip or may be implemented as a single chip including some or all of the circuits.

Circuit integration is not limited to LSI circuits; the elements may be implemented as a dedicated circuit or generic processor. A field programmable gate array (FPGA) that is programmable after manufacturing of the LSI circuit, or a reconfigurable processor whose circuit cell connections and settings in the LSI circuit are reconfigurable, may be used.

Note that, in the above-described embodiment, each of elements may be configured in the form of an exclusive hardware product or by executing a software program suitable for the element. Each element may be implemented as a result of a program execution unit, such as a central processing unit (CPU) or processor or the like, loading and executing a software program stored in a storage medium such as a hard disk or semiconductor memory.

The block diagrams illustrate examples of the division of functional blocks. Accordingly, a plurality of functional blocks may be implemented as a single functional block, a single functional block may be broken up into a plurality of functional blocks, and some of functions may be transferred to another functional block. Moreover, the functions of a plurality of function blocks having similar functions may be processed by a single piece of hardware or software in parallel or by time-division.

Note that the present disclosure also encompasses: embodiments achieved by applying various modifications conceivable to those skilled in the art to the above-described embodiment; and embodiments achieved by optionally combining the elements and the functions of the embodiment without departing from the spirit of the present disclosure.

While an embodiment has been described herein above, it is to be appreciated that various changes in form and detail may be made without departing from the spirit and scope of the present disclosure as presently or hereafter claimed.

Further Information about Technical Background to this Application

The disclosure of the following patent application including specification, drawings, and claims is incorporated herein by reference in their entirety: Japanese Patent Application No. 2024-168824 filed on Sep. 27, 2024.

### INDUSTRIAL APPLICABILITY

The in-vehicle input device and housing devices according to the present disclosure are useful for armrests provided in vehicles, vehicle console boxes, steering wheels, etc.

1. An in-vehicle input device provided in a vehicle, the in-vehicle input device comprising:
a resin panel having light transmissivity;
a design sheet provided on a front surface of the resin panel and including (i) a transmissive portion having light transmissivity and (ii) a design cover portion with a design, the design cover portion having light transmissivity lower than the light transmissivity of the transmissive portion;
a touch sensor sheet having light transmissivity and provided on a back surface of the resin panel to overlap at least the transmissive portion in a thickness direction of the in-vehicle input device, the back surface being on an opposite side relative to the front surface of the resin panel;
a pressure-sensitive sensor sheet having light transmissivity and provided on a second surface of the touch sensor sheet to overlap at least the transmissive portion in the thickness direction, the second surface being on an opposite side relative to a first surface of the touch sensor sheet on a resin panel side; and
a substrate provided to overlap the design cover portion in the thickness direction, and provided with a control circuit electrically connected with the touch sensor sheet and the pressure-sensitive sensor sheet.

2. The in-vehicle input device according to claim 1, further comprising:
a light-transmissive cover having light transmissivity and provided on an opposite side relative to a touch sensor sheet side of the pressure-sensitive sensor sheet, to cover the pressure-sensitive sensor sheet, the touch sensor sheet, and the substrate.

3. The in-vehicle input device according to claim 1, further comprising:
an actuator that is provided to overlap the design cover portion in the thickness direction and vibrates at least the transmissive portion.

4. The in-vehicle input device according to claim 3, wherein
the actuator is electrically connected with the control circuit, and
the control circuit controls the actuator based on an input detected by the touch sensor sheet and the pressure-sensitive sensor sheet.

5. The in-vehicle input device according to claim 1, wherein
the control circuit outputs information corresponding to an input detected by the touch sensor sheet and the pressure-sensitive sensor sheet to a display control circuit provided in the vehicle.

6. The in-vehicle input device according to claim 1, wherein
the vehicle is provided with a housing device,
the housing device is an armrest including a housing portion in which an opening is formed and a lid portion that opens and closes the opening, and
the in-vehicle input device is provided on the lid portion.

7. The in-vehicle input device according to claim 1, wherein
the in-vehicle input device is provided on a steering wheel of the vehicle.

8. A housing device comprising:
the in-vehicle input device according to claim 1;
a housing portion in which an opening is formed; and
a lid portion on which the in-vehicle input device is provided and which opens and closes the opening.

9. The housing device according to claim 8, wherein
the lid portion includes a space capable of accommodating a terminal device, and
the space overlaps the transmissive portion in the thickness direction.
